(19) United States
(12) Patent Application Publication
(10) Pub. No.: US 2020/0148052 A1
(43) Pub. Date: May 14, 2020

(54) DRIVE UNIT

(71) Applicant: HONDA MOTOR CO., LTD., Tokyo (JP)

(72) Inventors: Hideki Matsuoka, Wako-shi (JP); Kohji Imuta, Wako-shi (JP)

(21) Appl. No.: 16/677,864

(22) Filed: Nov. 8, 2019

(30) Foreign Application Priority Data
Nov. 13, 2018 (JP) 2018-212821

(51) Int. Cl. B60K 5/12; B62D 21/15; B62D 21/02; B62D 21/09

(52) U.S. Cl. CPC B60K 5/12; B62D 21/152; B60K 2001/0416; B62D 21/09; B62D 21/02

(57) ABSTRACT

A drive unit includes a battery, a battery exterior member, a motor, a motor exterior member, and at least one connection member. The battery exterior member accommodates the battery. The motor exterior member accommodates the motor. The connection member connects together the battery exterior member and the motor exterior member.

### CROSS-REFERENCE TO RELATED APPLICATION

Priority is claimed on Japanese Patent Application No. 2018-212821, filed on Nov. 13, 2018, the contents of which are incorporated herein by reference.

### BACKGROUND

### Field of the Invention

The present invention relates to a drive unit.

### Background

In the related art, a motor mount structure of an electric vehicle is known which includes a motor for travel driving having a drive shaft that extends in a vehicle width direction, a mount that elastically supports the drive shaft of the motor with respect to right and left side frames of a vehicle body, and a torque rod that connects together an outer circumferential part of the motor and a cross member (for example, refer to Japanese Unexamined Patent Application, First Publication No. H5-319103). In this motor mount structure, the mount cuts off a little vibration of the motor, and the torque rod prevents a rotation displacement of the motor by a drive reaction force.

### SUMMARY

According to the motor mount structure of the related art described above, the mount that supports the drive shaft of the motor is formed to have a fragility that actively releases the support of the motor in a case where an impact load of a predetermined amplitude or more acts. Accordingly, there is a probability that it is impossible to ensure a desired support strength and rigidity. Further, since the cross member to which the mount or the torque rod is connected is supported by the right and left side frames to which the mount is connected, there is a probability that it is impossible to sufficiently cut off the vibration of the motor to the vehicle body.

An aspect of the present invention provides a drive unit that is capable of preventing vibration which transmits to a vehicle body from a motor for travel driving and is capable of appropriately supporting a torque reaction force of the motor.

(1) A drive unit according to an aspect of the present invention includes: a battery; a battery exterior member that accommodates the battery; a motor that is configured to transmit and receives electric power to and from the battery; a motor exterior member that accommodates the motor; and at least one connection member that is configured to connect together the battery exterior member and the motor exterior member.

(2) In the above drive unit described in (1), the connection member may be provided on the battery exterior member or the motor exterior member.

(3) In the above drive unit described in (1) or (2), the battery and the motor may be provided on a vehicle and be arranged below a vehicle body floor in a vertical direction of the vehicle, and the connection member may connect together the motor exterior member and a rear end part of the battery exterior member in a front-to-rear direction of the vehicle.

(4) In the above drive unit described in (3) may include at least one second connection member that is configured to connect together the vehicle body floor and the motor exterior member.

(5) In the above drive unit described in (4), the connection member and the second connection member may be arranged in parallel in the front-to-rear direction when seen from a right-to-left direction of the vehicle.

(6) In the above drive unit described in (1) or (2), the battery and the motor may be provided on a vehicle and be arranged below a vehicle body floor in a vertical direction of the vehicle, and the connection member may connect together the motor exterior member and a front end part of the battery exterior member in a front-to-rear direction of the vehicle.

(7) The above drive unit described in (6) may include a torque rod that is arranged between the front end part and the motor exterior member, and the connection member may connect together the front end part and the motor exterior member via the torque rod.

According to the drive unit described in (1), since the battery has a relatively large mass in the drive unit, the battery exterior member that accommodates the battery is formed to ensure a high rigidity.

The connection member connects the motor exterior member directly to the battery exterior member. Thereby, the vibration force of the motor is absorbed by the battery and the battery exterior member, and it is possible to prevent the vibration that is configured to transmit externally from the motor and a vibration sound from occurring. Further, the connection member is able to appropriately support a torque reaction force of the motor by the battery and the battery exterior member.

Further, by the battery and the motor being integrated, it is possible to protect high voltage components such as the battery and the motor from an impact input from the outside, and it is possible to prevent a high voltage wiring that electrically connects between the high voltage components from increasing in length and prevent an increase of an electric resistance loss.

In the case (2) described above, since it is possible to provide the connection member on the battery exterior member or the motor exterior member, it is possible to improve the diverseness and easiness of the layout of the battery and the motor.

In the case (3) described above, in a rear-wheel drive vehicle, it is possible to appropriately support the torque reaction force of the motor by the battery and the battery exterior member.

In the case (4) described above, it is possible to prevent vibration which transmits to a vehicle body from the motor and a vibration sound from occurring, and it is possible to further appropriately support the torque reaction force of the motor.

In the case (5) described above, it is possible to further facilitate absorbing of the vibration force of the motor by the battery and the battery exterior member and supporting of the torque reaction force of the motor.

In the case (6) described above, in a front-wheel drive vehicle, it is possible to appropriately support the torque reaction force of the motor by the battery and the battery exterior member.

In the case (7) described above, it is possible to further appropriately support the torque reaction force of the motor by the torque rod.

### BRIEF DESCRIPTION OF THE DRAWINGS

FIG. 1 is a schematic diagram showing a configuration of part of a vehicle that includes a drive unit according to an embodiment of the present invention and is a view seen from a left side in a right-to-left direction of the vehicle.

FIG. 2 is a schematic diagram showing a configuration of part of the vehicle that includes the drive unit according to the embodiment and is a view seen from the above in a vertical direction of the vehicle.

FIG. 3 is a schematic diagram showing a configuration of a mount of the drive unit according to the embodiment.

FIG. 4 is a schematic diagram showing a configuration of a mount of a drive unit according to a first modified example of the embodiment.

FIG. 5 is a schematic diagram showing a configuration of part of a vehicle that includes a drive unit according to a second modified example of the embodiment and is a view seen from a left side in a right-to-left direction of the vehicle.

FIG. 6 is a schematic diagram showing a configuration of part of a vehicle that includes a drive unit according to a third modified example of the embodiment and is a view seen from a left side in a right-to-left direction of the vehicle.

FIG. 7 is a schematic diagram showing a configuration of part of a vehicle that includes a drive unit according to a fourth modified example of the embodiment and is a view seen from a left side in a right-to-left direction of the vehicle.

FIG. 8 is a schematic diagram showing a configuration of part of a vehicle that includes a drive unit according to a fifth modified example of the embodiment and is a view seen from a left side in a right-to-left direction of the vehicle.

FIG. 9 is a schematic diagram showing a configuration of part of a vehicle that includes a drive unit according to a sixth modified example of the embodiment and is a view seen from a left side in a right-to-left direction of the vehicle.

FIG. 10 is a schematic diagram showing a configuration of part of a vehicle that includes a drive unit according to a seventh modified example of the embodiment and is a view seen from a left side in a right-to-left direction of the vehicle.

### DESCRIPTION OF THE EMBODIMENTS

A drive unit according to an embodiment of the present invention will be described with reference to the drawings.

A drive unit according to the embodiment of the present invention is, for example, mounted on a vehicle 1. The vehicle 1 is, for example, an electric vehicle such as an electric automobile, a hybrid vehicle, and a fuel-cell vehicle. The electric automobile is driven using a battery as a power source. The hybrid vehicle is driven using a battery and an internal combustion engine as a power source. The fuel-cell vehicle is driven using a fuel cell as a drive source.

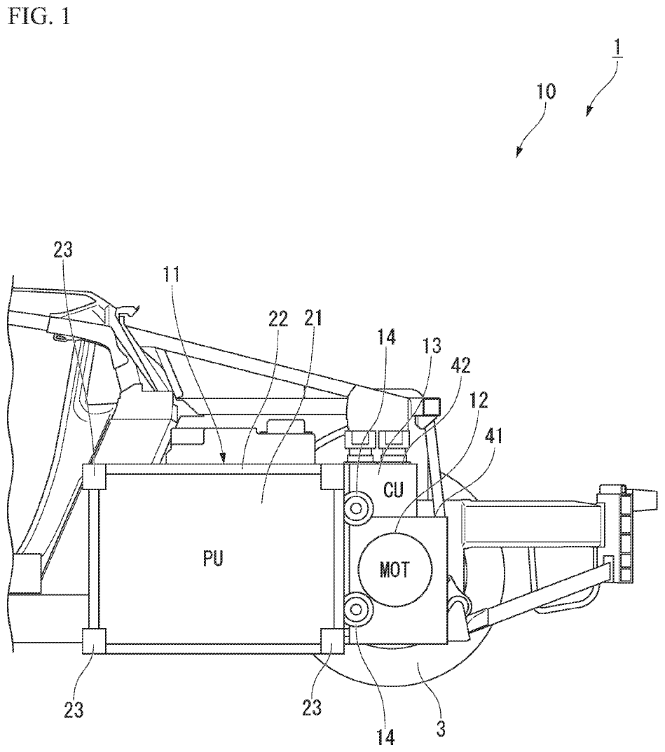

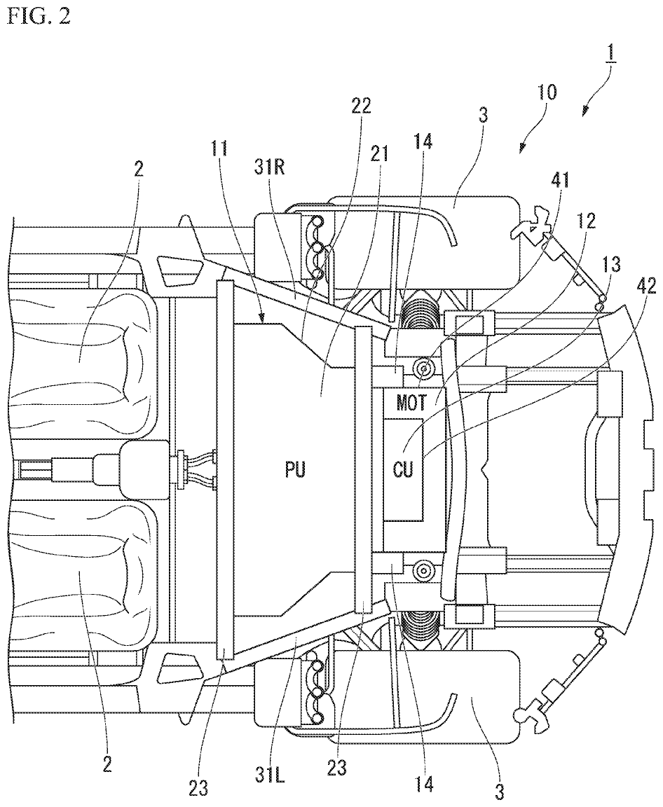

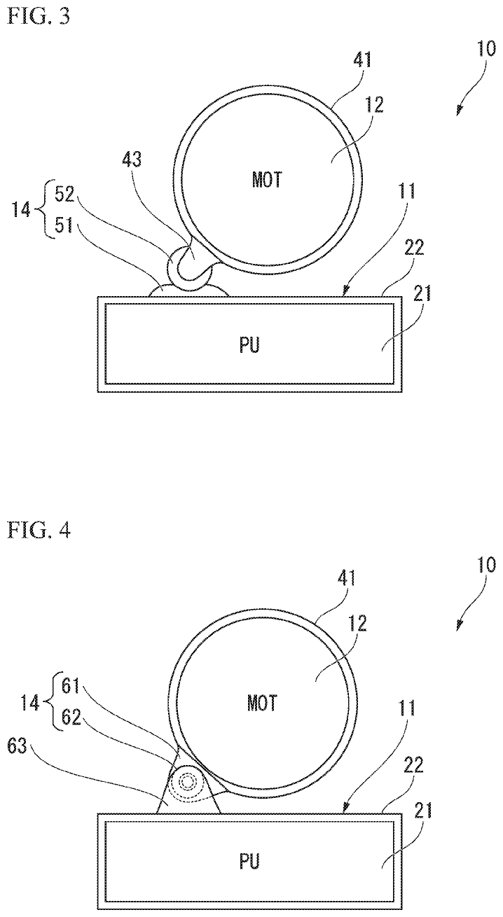

FIG. 1 is a schematic diagram showing a configuration of part of the vehicle 1 that includes a drive unit 10 according to the embodiment of the present invention and is a view seen from a left side in a right-to-left direction of the vehicle. FIG. 2 is a schematic diagram showing a configuration of part of the vehicle 1 that includes the drive unit 10 according to the embodiment of the present invention and is a view seen from the above in a vertical direction of the vehicle. FIG. 3 is a schematic diagram showing a configuration of a mount 14 (connection member) of the drive unit 10 according to the embodiment of the present invention.

As shown in FIG. 1 and FIG. 2, the drive unit 10 includes, for example, a power unit (PU) 11, a motor (MOT) 12, a control unit (CU) 13, and a plurality of mounts 14.

The power unit 11 is arranged, for example, at a rearward position of an occupant seat 2 of the vehicle 1. The power unit 11 includes a battery 21 and a battery case 22 (battery exterior member) that accommodates the battery 21. The battery 21 is a high-voltage electric storage device which is a power source of the vehicle 1. The battery 21 includes, for example, a plurality of battery modules that are accommodated in the battery case 22. The battery module includes a plurality of battery cells that are connected in series.

The battery case 22 is supported, for example, by a plurality of support frames 23. The plurality of support frames 23 are formed so as to extend in the right-to-left direction of the vehicle 1. The plurality of support frames 23 are fixed by right and left rear side frames 31L, 31R that constitute a vehicle body at a rear part of the vehicle 1.

The motor 12 is a rotary electric machine for driving the vehicle 1 to travel. A rotation shaft of the motor 12 is connected, for example, to a rear wheel 3 of the vehicle 1. The motor 12 generates a rotation drive force (power travel operation) by electric power supplied from the battery 21. The motor 12 may generate electric power generated by a rotation drive force that is input to the rotation shaft. For example, the motor 12 may be formed such that a rotation power of an internal combustion engine can be transmitted to the motor 12.

The motor 12 is, for example, a three-phase-AC brushless DC motor. The motor 12 includes a rotator having a field permanent magnet and a stator that generates a rotation magnetic field which rotates the rotator. The motor 12 is driven to be rotated by a three-phase-AC current that is output from the control unit 13. The motor 12 is accommodated inside a motor housing 41 (motor exterior member).

The control unit 13 includes, for example, an inverter that performs mutual conversion between DC electric power and AC electric power, a voltage converter that increases or decreases a voltage in between the battery 21 and the inverter or the like, a gate driver that controls the inverter and the voltage converter, a current sensor that measures a flowing current, and the like.

The control unit 13 is accommodated inside a unit case 42. The unit case 42 is, for example, arranged above the motor housing 41 and is fixed integrally to the motor housing 41.

The plurality of mounts 14 connects between the battery case 22 and the motor housing 41. The plurality of mounts 14 are provided, for example, on the battery case 22. The plurality of mounts 14 are, for example, fixed to a plurality of mount brackets 43 provided on the motor housing 41.

As shown in FIG. 3, each of the mounts 14 includes, for example, a base 51 that is fixed to the battery case 22 and a mount part 52 that is provided on the base 51. The mount part 52 is fixed to a mount bracket 43 of the motor housing 41, for example, by a fastening member such as a screw or a bolt.

As described above, according to the drive unit 10 of the present embodiment, the plurality of mounts 14 connect the motor housing 41 directly to the battery case 22 formed to have high rigidity for a battery 21 having a relatively large mass in the vehicle 1. Thereby, the vibration force of the motor 12 is absorbed by the power unit 11, and it is possible to prevent the vibration that is transmitted to the vehicle body from the motor 12 and a vibration sound from occurring. Further, the plurality of mounts 14 is able to appropriately support the torque reaction force of the motor 12 by the power unit 11.

Further, by the motor 12 and the battery 21 being integrated, it is possible to also integrate a protection member and easily protect high voltage components such as the motor 12 and the battery 21 from an impact that is input from the outside, and it is possible to prevent a high voltage wiring that electrically connects between the high voltage components from increasing in length and prevent an increase of an electric resistance loss.

Hereinafter, modified examples of the above embodiment are described.

In the above embodiment, the plurality of mounts 14 are provided on the battery case 22; however, the embodiment is not limited thereto, and the plurality of mounts 14 may be provided on the motor housing 41.

FIG. 4 is a schematic diagram showing a configuration of a mount 14 of a drive unit 10 according to a first modified example of the embodiment of the present invention.

As shown in FIG. 4, in the drive unit 10 according to the first modified example, the plurality of mounts 14 are provided on the motor housing 41. Each of the mounts 14 includes, for example, a base 61 that is fixed to the motor housing 41 and a mount part 62 that is provided on the base 61.

The mount part 62 is fixed to a mount bracket 63 of the battery case 22, for example, by a fastening member such as a screw or a bolt.

According to the first modified example, it is possible to provide the plurality of mounts 14 on the battery case 22 or the motor housing 41, and it is possible to improve the diverseness and easiness of the layout of the battery 21 and the motor 12.

In the above embodiment, the power unit 11 is arranged at a rearward position of the occupant seat 2 of the vehicle 1; however, the embodiment is not limited thereto. For example, the power unit 11 may be arranged below a vehicle body floor 71 of the vehicle 1.

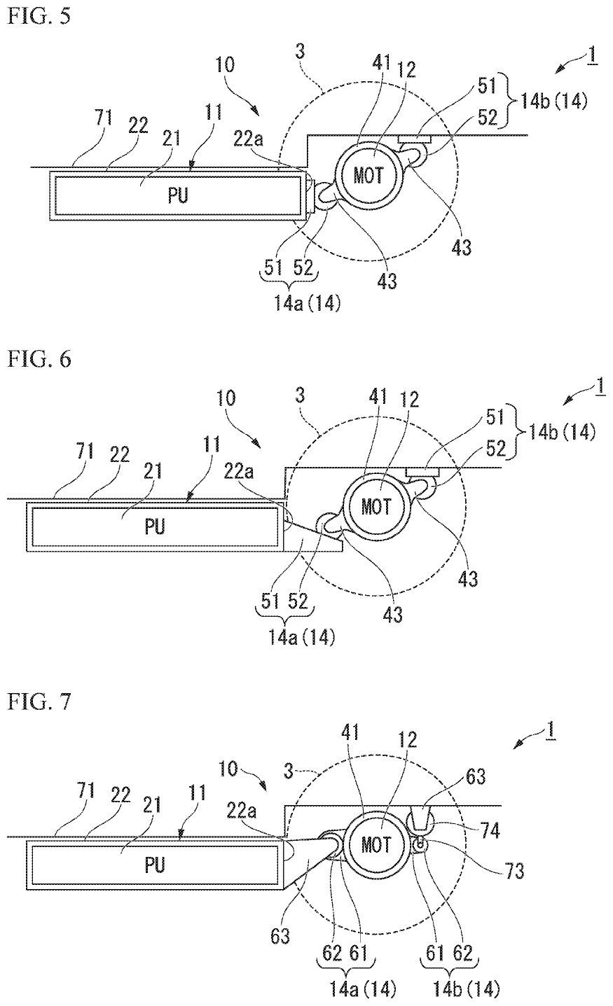

FIG. 5 is a schematic diagram showing a configuration of part of a vehicle 1 that includes a drive unit 10 according to a second modified example of the embodiment of the present invention and is a view seen from a left side in the right-to-left direction of the vehicle 1.

As shown in FIG. 5, in the drive unit 10 according to the second modified example, the power unit 11 and the motor 12 are arranged below the vehicle body floor 71 at a rear part of the vehicle 1.

A first mount 14a (connection member) among the plurality of mounts 14 connects a rear end part 22a of the battery case 22 and the mount bracket 43 that is provided on the motor housing 41. For example, the first mount 14a includes a base 51 that is fixed to the rear end part 22a of the battery case 22 and a mount part 52 that is provided on the base 51.

A second mount 14b (second connection member) among the plurality of mounts 14 connects the vehicle body floor 71 and the mount bracket 43 that is provided on the motor housing 41. For example, the second mount 14b includes a base 51 that is fixed to the vehicle body floor 71 and a mount part 52 that is provided on the base 51.

According to the second modified example, in a rear-wheel drive vehicle 1, it is possible to prevent the vibration that is transmitted to the vehicle body from the motor 12 and a vibration sound from occurring, and it is possible to appropriately support the torque reaction force of the motor 12 by the power unit 11.

In the above second modified example, for example, in accordance with the enlargement of a wheel base of the vehicle 1 or the like, the base 51 of the mount 14 or the mount bracket 43 may be formed to be long.

FIG. 6 is a schematic diagram showing a configuration of part of a vehicle 1 that includes a drive unit 10 according to a third modified example of the embodiment of the present invention and is a view seen from a left side in a right-to-left direction of the vehicle 1.

As shown in FIG. 6, in the drive unit 10 according to the third modified example, the base 51 of the first mount 14a is formed to be longer than that of the second modified example, for example, in accordance with the enlargement of the wheel base at the rear part of the vehicle 1 or the like.

According to the third modified example, even in a case where a resonance frequency is decreased by the base 51 of the mount 14 or the mount bracket 43 being elongated, it is possible to prevent a little vibration of the motor 12 from being amplified and being transmitted to the vehicle body by the mass of the power unit 11, and it is possible to ensure a desired vibration cutoff performance for the motor 12.

In the second modified example and the third modified example described above, the first mount 14a and the second mount 14b may be arranged in parallel with the front-to-rear direction of the vehicle 1.

FIG. 7 is a schematic diagram showing a configuration of part of a vehicle 1 that includes a drive unit 10 according to a fourth modified example of the embodiment of the present invention and is a view seen from a left side in a right-to-left direction of the vehicle 1.

As shown in FIG. 7, in the drive unit 10 according to the fourth modified example, the first mount 14a and the second mount 14b are arranged in parallel with the front-to-rear direction of the vehicle 1 when seen from the right-to-left direction of the vehicle 1.

The first mount 14a connects the motor housing 41 and the mount bracket 63 that is provided on the rear end part 22a of the battery case 22. For example, the first mount 14a includes a base 61 that is fixed to a front end part of the motor housing 41 and a mount part 62 that is provided on the base 61.

The second mount 14b connects the motor housing 41 and the mount bracket 63 that is provided on the vehicle body floor 71. For example, the second mount 14b includes a base 61 that is fixed to a rear end part of the motor housing 41 and a mount part 62 that is provided on the base 61. The mount part 62 is connected to the mount bracket 63 of the vehicle body floor 71, for example, via a rod-like member 73 that extends in the vertical direction of the vehicle 1 and an attachment member 74 that is provided on the rod-like member 73.

According to the fourth modified example, it is possible to further facilitate absorbing of the vibration force of the motor 12 by the power unit 11 and supporting of the torque reaction force of the motor 12.

In the second modified example and the third modified example described above, the first mount 14a and the second mount 14b may connect the motor housing 41 and a plurality of different parts of the battery case 22 below the vehicle body floor 71.

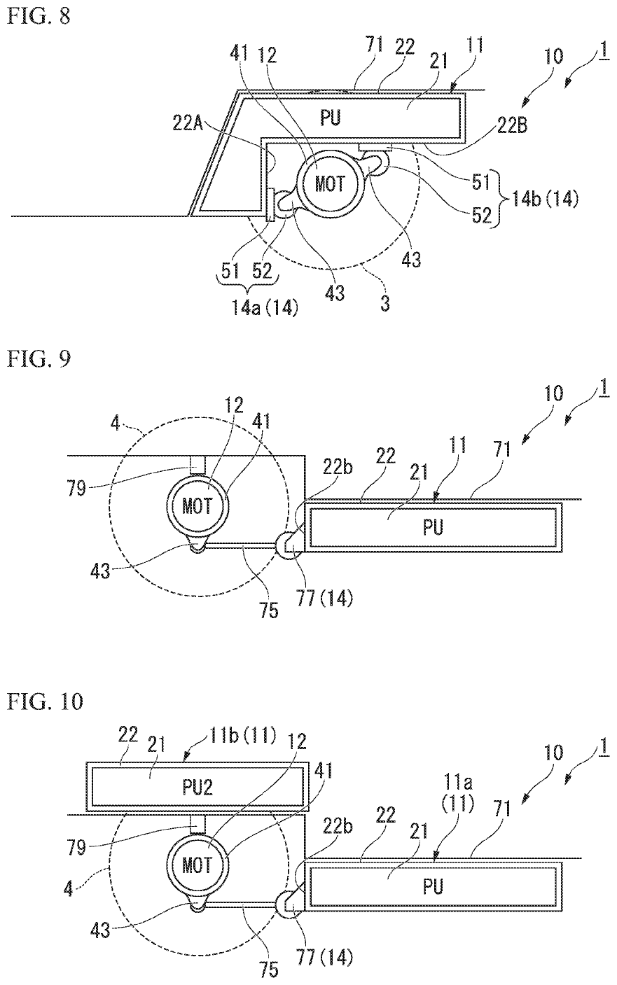

FIG. 8 is a schematic diagram showing a configuration of part of a vehicle 1 that includes a drive unit 10 according to a fifth modified example of the embodiment of the present invention and is a view seen from a left side in the right-to-left direction of the vehicle 1.

As shown in FIG. 8, in the drive unit 10 according to the fifth modified example, the first mount 14a and the second mount 14b connect the mount bracket 43 that is provided on the motor housing 41 and a plurality of different parts of the battery case 22 that are arranged so as to surround the motor housing 41.

For example, the first mount 14a includes a base 51 that is fixed to a rear surface 22A of the battery case 22 and a mount part 52 that is provided on the base 51. The second mount 14b includes a base 51 that is fixed to a lower surface 22B of the battery case 22 and a mount part 52 that is provided on the base 51.

In the second to fifth modified examples described above, the power unit 11 is arranged at a rearward position of the occupant seat 2 of the vehicle 1; however, the embodiment is not limited thereto. For example, the power unit 11 may be arranged at a front part of the vehicle 1.

FIG. 9 is a schematic diagram showing a configuration of part of a vehicle 1 that includes a drive unit 10 according to a sixth modified example of the embodiment of the present invention and is a view seen from a left side in the right-to-left direction of the vehicle 1.

As shown in FIG. 9, in the drive unit 10 according to the sixth modified example, the power unit 11 and the motor 12 are arranged below the vehicle body floor 71 at a front part of the vehicle 1. A rotation shaft of the motor 12 is connected to a front wheel 4 of the vehicle 1.

The plurality of mounts 14 connect between a front end part 22b of the battery case 22 and the mount bracket 43 that is provided on the motor housing 41, for example, via a torque rod 75 that extends in the front-to-rear direction of the vehicle 1. For example, each of the mounts 14 includes a case-side bracket 77 that is fixed to the front end part 22b of the battery case 22. A first end part of the torque rod 75 is connected to the case-side bracket 77, and a second end part of the torque rod 75 is connected to the mount bracket 43 of the motor housing 41.

Further, for example, an upper end part of the motor housing 41 is connected to an attachment member 79 that is fixed to the vehicle body floor 71.

According to the sixth modified example, in a front-wheel drive vehicle 1, it is possible to prevent the vibration that is transmitted to the vehicle body from the motor 12 and a vibration sound from occurring, and it is possible to appropriately support the torque reaction force of the motor 12 by the power unit 11.

In the sixth modified example described above, the drive unit 10 may include a plurality of power units 11.

FIG. 10 is a schematic diagram showing a configuration of part of a vehicle 1 that includes a drive unit 10 according to a seventh modified example of the embodiment of the present invention and is a view seen from a left side in the right-to-left direction of the vehicle 1.

As shown in FIG. 10, the drive unit 10 according to the seventh modified example includes a first power unit 11a and a second power unit 11b.

The first power unit 11a and the motor 12 are arranged below the vehicle body floor 71 at a front part of the vehicle 1. The plurality of mounts 14 connect between a front end part 22b of the battery case 22 of the first power unit 11a and the mount bracket 43 that is provided on the motor housing 41, for example, via a torque rod 75 that extends in the front-to-rear direction of the vehicle 1.

The second power unit 11b is arranged above a part of the vehicle body floor 71 to which the attachment member 79 is fixed.

According to the seventh modified example, it is possible to further facilitate absorbing of the vibration force of the motor 12 by the plurality of power units 11 and supporting of the torque reaction force of the motor 12.

The embodiments of the present invention are described as an example, and the invention is not limited to the embodiments. The embodiments can be implemented as a variety of other embodiments, and a variety of omissions, replacements, and changes can be made without departing from the scope of the invention. The embodiments and modifications of the embodiments are included in the scope of the invention and also included in the invention described in the claims and equivalents thereof.

What is claimed is:

1. A drive unit comprising:
a battery;
a battery exterior member that accommodates the battery;
a motor that is configured to transmit and receives electric power to and from the battery;
a motor exterior member that accommodates the motor; and
at least one connection member that is configured to connect together the battery exterior member and the motor exterior member.

2. The drive unit according to claim 1,
wherein the connection member is provided on the battery exterior member or the motor exterior member.

3. The drive unit according to claim 1,
wherein the battery and the motor are provided on a vehicle and are arranged below a vehicle body floor in a vertical direction of the vehicle, and
the connection member connects together the motor exterior member and a rear end part of the battery exterior member in a front-to-rear direction of the vehicle.

4. The drive unit according to claim 3, comprising
at least one second connection member that is configured to connect together the vehicle body floor and the motor exterior member.

5. The drive unit according to claim 4,
wherein the connection member and the second connection member are arranged in parallel in the front-to-rear direction when seen from a right-to-left direction of the vehicle.

6. The drive unit according to claim 1,
wherein the battery and the motor are provided on a vehicle and are arranged below a vehicle body floor in a vertical direction of the vehicle, and
the connection member connects together the motor exterior member and a front end part of the battery exterior member in a front-to-rear direction of the vehicle.

7. The drive unit according to claim 6, comprising
a torque rod that is arranged between the front end part and the motor exterior member,
wherein the connection member connects together the front end part and the motor exterior member via the torque rod.

8. The drive unit according to claim 2,
wherein the battery and the motor are provided on a vehicle and are arranged below a vehicle body floor in a vertical direction of the vehicle, and
the connection member connects together the motor exterior member and a rear end part of the battery exterior member in a front-to-rear direction of the vehicle.

9. The drive unit according to claim 2,
wherein the battery and the motor are provided on a vehicle and are arranged below a vehicle body floor in a vertical direction of the vehicle, and
the connection member connects together the motor exterior member and a front end part of the battery exterior member in a front-to-rear direction of the vehicle.

10. The drive unit according to claim 9, comprising
a torque rod that is arranged between the front end part and the motor exterior member,
wherein the connection member connects together the front end part and the motor exterior member via the torque rod.
